(19) United States
(12) Patent Application Publication
(10) Pub. No.: US 2020/0130282 A1
(43) Pub. Date: Apr. 30, 2020

(54) THERMAL IMAGE AND 3D PRINT PROCESS SYNCHRONIZATION

(71) Applicant: HEWLETT-PACKARD DEVELOPMENT COMPANY, L.P., Spring, TX (US)

(72) Inventors: Jian Fan, Palo Alto, CA (US); Andrew E Fitzhugh, Palo Alto, CA (US); Jerry Jin-Tzong Liu, Palo Alto, CA (US)

(21) Appl. No.: 16/605,714

(22) PCT Filed: Apr. 3, 2018
(86) PCT No.: PCT/US18/25818

§ 371 Date: Oct. 16, 2019

(51) Int. Cl. B29C 64/393; B33Y 50/02; G05B 19/4097

(52) U.S. Cl. CPC B29C 64/393; B33Y 50/02; G05B 2219/36175; G05B 2219/49023; G05B 19/4097

(57) ABSTRACT

Examples disclosed herein relate to synchronize a thermal image and a 3D print process. In one implementation, a processor synchronizes a thermal image with a step in a 3D printing process based on an occluded region detected in the thermal image. The processor may output thermal information associated with the 3D print process step.

### BACKGROUND

Thermal conditions during a 3D print process may affect properties of a created 3D printed part. Thermal metrics may be collected in relation to a 3D printing process. For example, thermal information captured during a 3D printing process may be analyzed when a created part does not meet target mechanical or geometric characteristics.

### BRIEF DESCRIPTION OF THE DRAWINGS

The drawings describe example embodiments. The following detailed description references the drawings, wherein:

FIG. 1 is a block diagram illustrating one example of a computing system to synchronize a thermal image with a 3D print process.

FIG. 2 is a flow chart illustrating one example of a method to synchronize a thermal image with a 3D print process.

FIG. 3A is a diagram illustrating one example of identifying occlusion based on a comparison of thermal images.

FIG. 3B is a diagram illustrating one example of a 3D print process flow with associated thermal images.

FIG. 4 is a diagram illustrating one example of a process workflow state diagram for a 3D print process.

FIG. 5 is a flow chart illustrating one example of a method to synchronize a thermal image with a 3D print process.

### DETAILED DESCRIPTION

Thermal conditions during a 3D print process may affect the fusing of a part and its resulting mechanical and geometric properties. Thermal information related to a 3D print process may be useful for predicting properties of a resulting printed part. In addition, if a part is produced with a particular weakness, an analysis of thermal information during the 3D print process may identify a contributing issue to the part weakness, and the 3D print process may be altered for future batches.

In one implementation, a processor associates a set of thermal images captured during a 3D print process with a step in the 3D print process based on an analysis of the thermal images. For example, a processor may synchronize a thermal image with a step in a 3D printing process based on occlusion detected in the thermal image. The occlusion may be caused by a mechanism of the 3D printer, such as by a powder spreader or print carriage. The processor may associate a print layer mask with the thermal images based on the 3D printing process step associated with the thermal images and output thermal metrics associated with the 3D print layer mask.

Detecting occlusion in thermal images may be used both to remove occluded portions of thermal images to provide better thermal data and to synchronize print layer masks with the thermal images to provide more useful thermal information. For example, thermal metrics associated with a particular stage of the 3D print process may indicate thermal conditions in a layer by layer manner. Thermal conditions in the 3D print process may be affected by many conditions, such as part shape, print history, and material, making it difficult to create a thermal model without thermal measurements. Synchronizing the 3D print process with thermal images based on occlusion allows thermal images to be synchronized independent of printer firmware control. Information about the specific print process workflow determined based on the occluded regions allows thermal images to be synchronized even when information about the specific print process workflow is not communicated in advance. For example, a thermal camera may be an additional component to a 3D printer system without integration into the 3D printing device itself.

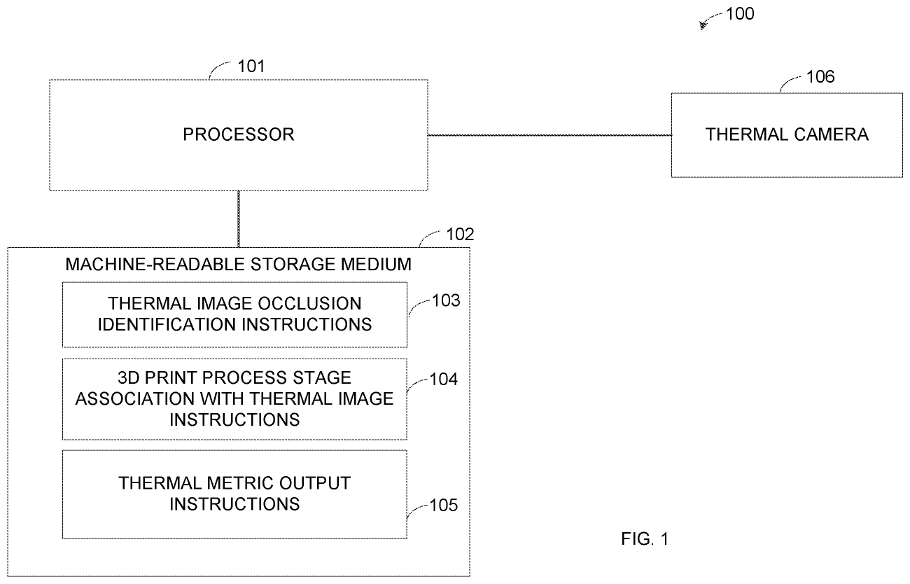

FIG. 1 is a block diagram illustrating one example of a computing system 100 to synchronize a thermal image with a 3D print process. For example, the computing system 100 may analyze captured thermal images and synchronize the thermal images with the 3D print process based on occlusion in the images caused by mechanisms of the 3D printer. The thermal images may provide applicable information to the 3D printing process when associated with a step of the 3D printing process, such as the application of a particular agent or fusing of a particular layer. The computing system 100 includes a thermal camera 106, processor 101, and machine-readable non-transitory storage medium 102.

The thermal camera 106 may be any suitable thermal camera, such as a FLIR camera. The thermal camera 106 may be positioned in a manner to capture images of a part being 3D printed during the print process. For example, the thermal camera 106 may capture images of a 3D print build area, such as a 3D print powder bed. The thermal images captured by the thermal camera 106 may be of any suitable target, such as of a portion of a 3D print bed or an entire bed. The images may be captured to show a thermal view of the print bed and changes as successive layers are fused. The thermal camera 106 may be in a fixed position relative to the 3D printer print bed. In one implementation, the computing system 100 includes multiple thermal cameras from which a thermal image with aggregated thermal information is stitched together from the output of multiple thermal cameras.

The thermal camera 106 may be in any suitable position relative to the 3D print bed. In one implementation, the thermal camera 106 is aligned with a direction of a print mechanism causing occlusion. For example, a 3D printer may have a first mechanism, such as a powder spreader, aligned horizontally with the print bed and a second mechanism, such as a print carriage, aligned vertically with the print bed. The thermal camera 106 may be positioned to be aligned horizontally or vertically to align with one of the print mechanisms.

The thermal camera 106 may capture images at different points during the 3D print process. For example, the thermal camera 106 may capture images at regular intervals or may record video of the 3D printing process. The thermal camera 106 may store thermal images, such as recorded video, to be accessed by the processor 101. In one implementation, the processor 101 analyzes captured images from the thermal camera 106 in real time. In one implementation, the computing system 100 is a cloud based system such that the thermal cameral 106 is positioned relative to the 3D printer, and the processor 101 is a remote device to receive thermal information from a storage.

The processor 101 may calibrate the thermal camera 106 initially and/or periodically. The processor may calibrate the thermal camera by automatically or semi-manually matching points in the image with locations on the 3D print area. In one implementation, the processor 101 may correct perspective distortion caused by the thermal camera 106 being oblique to the print area surface.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 includes thermal image occlusion identification instructions 103, 3D print process stage association with thermal image instructions 104, and thermal metric output instructions 105.

The thermal image occlusion identification instructions 103 may include instructions to identify occlusion in a captured first thermal image based on a comparison of the thermal image to a previously captured second thermal image. For example, the thermal camera 106 may capture successive thermal images of a 3D print bed. The processor 101 may compare a thermal image to a previously capture thermal image to detect occlusion. The processor 101 may detect occlusion based on a comparison of differences in pixel values in a previously captured image to a subsequently captured image. For example, an amount, rate, or other information related to change between pixel values of pixels in the same position may be compared. In one implementation, the processor 101 identifies occlusion based on a comparison of whether a value difference in a pixel position between the first and second thermal image is above a threshold. In one implementation, a pixel is categorized as occluded within an image, and an image is determined to include occlusion if the number of pixels in the thermal image categorized as occluded is above a threshold.

Any suitable number of thermal images in any suitable order may be compared to identify occlusion. For example, an amount of change in a pixel value across a set of images may be compared. The thermal images may be compared to thermal images taken directly after one another or at different intervals. The thermal images may be image frames in a recorded thermal video.

The 3D print process stage association with thermal image instructions 104 may include instructions to determine a 3D print process stage associated with the thermal image based on a 3D printer movement indicated by the identified occlusion. For example, the 3D print process stage may be determined based on the length, width, orientation, or other information related to an occluded area of the thermal image. For example, a print bar or other print mechanism may have a particular width, move across the print bed in a particular direction, or limit its movement to a particular portion of the print bed. In one implementation, the processor 101 determines an orientation of a set of occluded pixels within the thermal image, such as whether an occluded region is horizontal or vertical across a print bed, and determines the 3D print process stage based on the determined orientation. As an example, a powder spreader may move vertically across a print bed, and a print bar dispensing a liquid agent may move horizontally across a print bed. In one implementation, the orientation of the occluded region is used to confirm that the occlusion is due to the print process. For example, print mechanisms in a particular 3D printer may move in a single direction, and the orientation of occlusion may be used to confirm that it is associated with a 3D print mechanism.

Associating the thermal image with the 3D print process stage may involve associating thermal measurements of non-occluded regions with the determined 3D print process stage. For example, the thermal measurements may be associated with a print layer mask indicating fused and non-fused regions at the associated 3D print process stage.

In one implementation, the computing system 100 includes a storage to store information associated with the 3D print process such that an occlusion characteristic may be associated with a step in a workflow. In some cases, some steps in a workflow may be iterative a variable number of times, and the thermal images may be used to determine the number of iterations. Associating the thermal image with the 3D print process stage may involve comparing the change in the associated stage with a previously determined 3D print stage to track the progress of the 3D print process along the workflow. In one implementation, thermal data from a subsequently captured non-occluded image may be used to provide thermal information related to the 3D print process. The thermal data may be associated with a stage in the 3D print process based on occlusion identified in a previously captured image. For example, non-occluded images captured between the capture time of two images with identified occlusion may be associated with a 3D print stage based on a position in a workflow between the two identified stages. Thermal metrics may be determined for the non-occluded images and associated with a print mask at the particular 3D print workflow stage.

The thermal metric output instructions 105 may include instructions to output the thermal characteristics of the 3D print conditions based on the thermal images and associated 3D print process stages. For example, thermal conditions associated with the 3D print process stage may indicate thermal conditions due to a fusing agent, color agent, conductive agent, and/or other agent applied to the build material. The thermal conditions may be associated with a print process stage such that the thermal conditions may be associated with a type of energy application. The thermal metrics may be output in any suitable manner, such as where the thermal metrics are stored, displayed, or transmitted.

Any suitable thermal metrics may be determined. For example, the processor may compare a maximum, minimum, average, and/or standard deviation of temperature measurements between different areas of a single layer or between multiple layers. The processor may determine a level of thermal uniformity of a layer and/or between layers based on the thermal metrics. The thermal information may be used to determine likely properties of the 3D printed part, such as part strength, and/or to determine the cause of a weakness in a resulting 3D printed part. In one implementation, the thermal information is used to update the 3D printing process for a subsequently printed part to improve thermal conditions in future 3D printing processes.

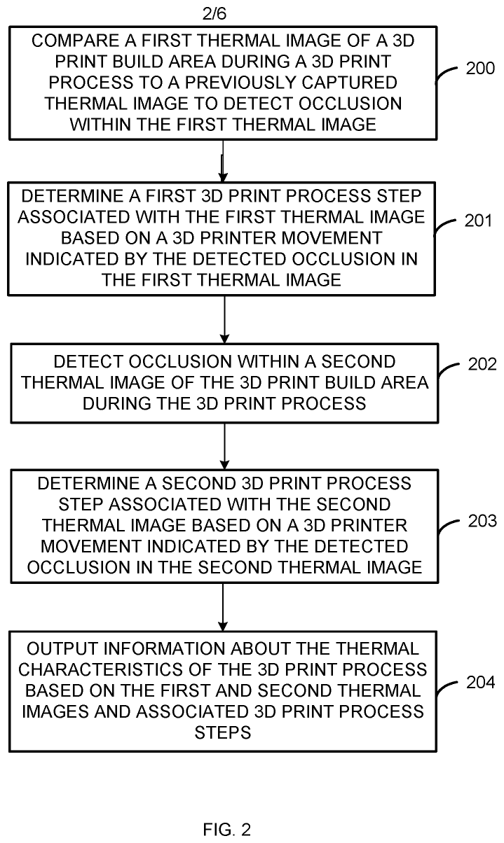

FIG. 2 is a flow chart illustrating one example of a method to synchronize a thermal image with a 3D print process. For example, a processor may compare thermal images to synchronize print stages with different sets of thermal images. The synchronization may be based on occlusion in the thermal images associated with the 3D print process, such as occlusion caused by a print bar moving between a print bed and thermal camera. The synchronization may allow for the thermal image information to be associated with individual steps of the 3D print process. The method may be implemented, for example, by the computing system 100 of FIG. 1.

Beginning at 200, a processor compares a first thermal image of a 3D print build area during a 3d print process to a previously captured thermal image to detect occlusion within the first thermal image. For example, the processor may compare a change over time between thermal images captured from a thermal camera at the same position. In one implementation, occlusion is identified based on pixel differences above a threshold between two thermal images. For example, the processor may determine an absolute value of a difference in a pixel value between a pixel in the same position in two successive images. The threshold for identifying occlusion may be different according to a capture time difference between thermal images. The occlusion information may be disregarded if the number of identified pixels with occlusion is below a threshold. The processor may analyze changes across multiple thermal images captured at different times to identify occlusion. The processor may determine pixels that are occluded and store information about the particular pixels such that the position of the occluded pixels is stored. As an example, the processor may store a pixel mapping with a 0 or 1 for each pixel position depending on whether it is identified as occluded or not. The processor may determine whether a thermal image is occluded based on the number of occluded pixels in the thermal image. For example, a small amount of occlusion may be due to causes other than the movement of the 3D printer. The processor may compare the number of occluded pixels to a threshold to determine if an image is occluded. In one implementation, the processor determines whether the occluded pixels are clustered into an occluded region. For example, an occluded pixel surrounded by non-occluded pixels may be disregarded.

Continuing to 201, the processor determines a first 3D print process step associated with the first thermal image based on a 3D printer movement indicated by the detected occlusion in the first thermal image. The movement may be any suitable movement caused during a 3D print process, such as related to spreading build material, dispensing agents, or performing post processing activities. For example, the movement may be associate with a mechanism moving between the thermal camera and a 3D print area, such as a powder bed.

The processor may determine the printer movement based on a characteristic of the occlusion, such as the width, length, position, and/or orientation of an occluded region. The processor may use any suitable image analysis method to analyze the occlusion. For example, the processor may use an optical flow method to detect object motion between the thermal images.

In one implementation, the occluded region caused by the print mechanism may include a set of pixels where at least one edge is a straight line or substantially a straight line, such as caused by a linear edge of a print bar. For example, the processor may identify an edge of an occluded region by analyzing each pixel in a first column and first row in the thermal image and moving down the row until an occluded pixel is encountered. In one implementation, the processor stores an array the size of the columns of pixels in the thermal image such that array values relate to the position of the first and/or last occluded pixel position in the particular column. The processor may determine if the edge of the occlusion is in the form of a line indicative of occlusion caused by a print mechanism. For example, the processor may apply a RANSAC method or another similar method to detect a line based on the array values. The processor may detect a line based on the number of columns with an edge occluded pixel within a threshold distance of a line and/or the mean square error of the distances of the edge occluded pixels to the line is less than a threshold. If a line is detected, the processor may compare the line to a line detected in a previous thermal image frame to determine the movement, such as top down or bottom up. A similar method may be applied for detecting vertical movement of a substantially straight print mechanism, such as due to a build material spreader.

In some cases, the occlusion may be irregular and not likely to fit to a straight line. For example, the horizontal movement of a print bar for distributing a fusing agent may not cause occlusion in a straight line if the thermal camera is positioned relative to a vertical mechanism. The processor may detect left and right edge pixels of an occluded region. The processor may store the information in an array the size of the number of rows of pixels with a value related to the position of an edge occluded pixel. The processor may apply 1D median filtering to edge points to remove outliers and compare the positions of the edge pixels between thermal image frames to determine a direction of movement. A similar method may be applied to an irregular vertical movement component.

The processor may associate the thermal image with a step in a 3D print process workflow if the occlusion orientation is associated with a particular step, such as horizontal occlusion associated with a print bar that moves horizontally across a print bed.

In one implementation, the occlusion may not be associated with a print process and may be disregarded if it does not fit a pattern type associated with a step in the print process. For example, diagonal occlusion may be disregarded in a system with print mechanisms that move horizontally and vertically.

The processor may associate non-occluded portions of the thermal image with the determined 3D print step. For example, the thermal measurements from non-occluded portions may be associated with a print mask at the determined 3D print step. The processor may set a current 3D print step as the determined step and a subsequently captured image without detected occlusion may be associated with the current 3D print step. In one implementation, thermal information from multiple images associated with a 3D print process step is aggregated, such as to provide aggregated metrics associated with the particular step. For example, a maximum and minimum temperature measured across a layer may be determined.

Continuing to 202, the processor detects occlusion within a second thermal image of the 3D print build area during the 3D print process. For example, the processor may compare the second thermal image to the first thermal image or to another previously captured thermal image to determine if the second thermal image includes an occluded region. The processor may detect occlusion based on the amount of difference between pixels in the same position between the second thermal image and a previously captured thermal image and based on the number of pixels with occlusion within second the thermal image.

Continuing to 203, the processor determines a second 3D print process step associated with the second thermal image based on a 3D printer movement indicated by the detected occlusion in the second thermal image. For example, the processor may determine the 3D print process based on a characteristic of the occlusion, such as in a manner similar to a method applied for the first thermal image. The processor may associate non-occluded regions of the second thermal image with the second 3D print process step.

Continuing to 204, the processor outputs information about the thermal characteristics of the 3D print process based on the first and second thermal images and associated 3D print process steps. For example, non-occluded images and/or non-occluded portions of images may be used to determine thermal metrics according to their associated 3D print processes. The metrics may be associated with the 3D print stage associated with the thermal measurements. The thermal metrics may be determined based on whether temperature measurements are related to printed or non-printed regions, and the status of the print regions may be determined based on the stage in the 3D print process step.

The processor may analyze any suitable number of thermal images and determine any suitable number of 3D print process steps. For example, the processor may determine thermal metrics for multiple stages of the 3D print process. The processor may associate thermal measurements with a stored 3D print process workflow, such as a stored process state diagram. In one implementation, the processor creates a 3D print process workflow based on the determined 3D print process step information determined from the thermal images. For example, certain steps may iterate a variable number of times depending on the object being 3D printed, and the processor may determine the number of iterations based on the thermal images.

The process workflow may have any suitable number of states. For example, there may be different types of mechanisms that move in the same direction with other differentiating characteristics between them, such as width. There may be any suitable number of possible orientations for the 3D print mechanisms. For example, a fusing agent print bar may move horizontally, a color agent print bar may move diagonally, and a build material spreader may move vertically.

In one implementation, the processor performs post processing on thermal images prior to determining thermal metrics. For example, the processor may perform perspective correction or other correction prior to determining thermal metrics. The perspective correction may be performed based on the position of the thermal camera relative the 3D print build area.

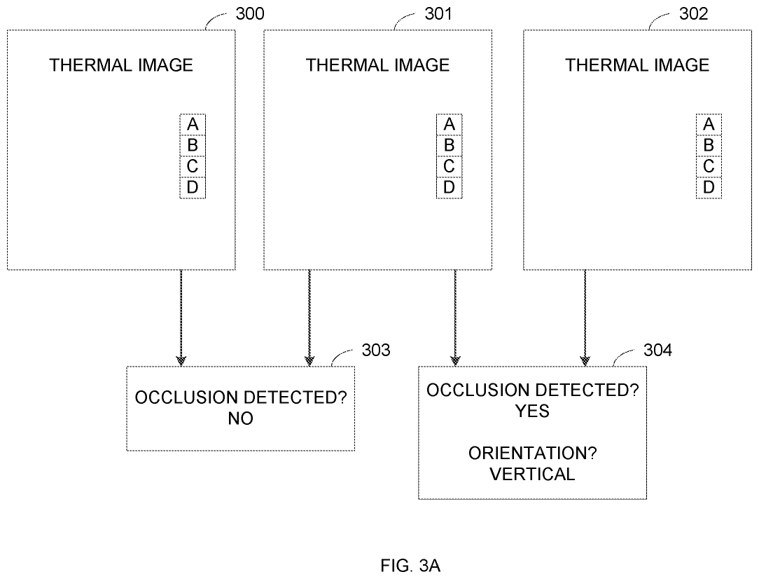

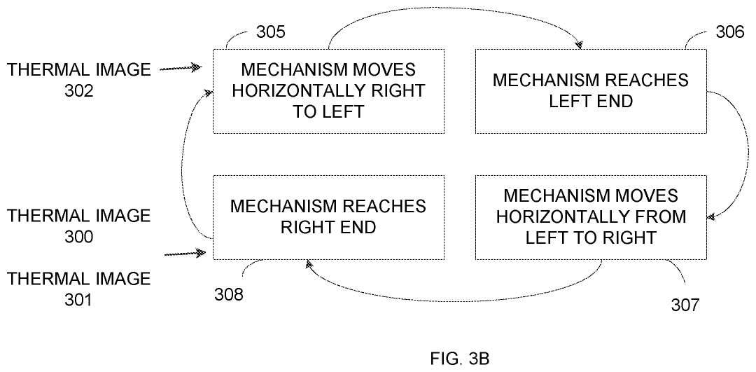

FIG. 3A is a diagram illustrating one example of identifying occlusion based on a comparison of thermal images. Thermal images 300-302 are captured in order such that thermal image 300 is captured prior to thermal image 301, and thermal image 302 is captured prior to thermal image 302. Pixels A-D are shown across the three thermal images 300-301. In one implementation, a processor may compare the value of pixel A in thermal images 300, 301, and 302 to determine if pixel A is occluded in any of the images. Similarly, pixels B, C, and D may be compared across thermal images 300, 301, and 302.

Block 303 shows that occlusion was not detected between the pixel values of thermal images 300 and 301. Block 304 shows that occlusion was detected between the pixel values of thermal images 301 and 302 and that the orientation of the occlusion was vertical. For example, each of pixels A, B, C, and D may be occluded.

FIG. 3B is a diagram illustrating one example of a 3D print process flow with associated thermal images 300-302 from FIG. 3A. The 3D print process flow includes four steps. Step 305 involves a mechanism, such as a powder spreader or agent distributor, moving horizontally across the print bed right to left. At step 306, the mechanism reaches the left end of the mechanism's path across the print bed. At step 307, the mechanism moves horizontally across the print bed left to right. At step 308, the mechanism reaches the right end of the mechanism's path across the print bed.

A processor may associate the images in FIG. 3A with steps in the print process workflow of FIG. 3B. For example, the thermal images 300 and 301 may be associated with step 308 with the mechanism reaching the right end of its path across the print bed. There may be multiple images captured at the stage with no occlusion, such as during a cooling period. The thermal image 302 may be associated with step 305 because the occlusion indicates that a mechanism has started moving horizontally across the print bed again. Any suitable number of thermal images may be associated with each step. For example, there may be many thermal images captured as the horizontal mechanism moves horizontally across the print bed.

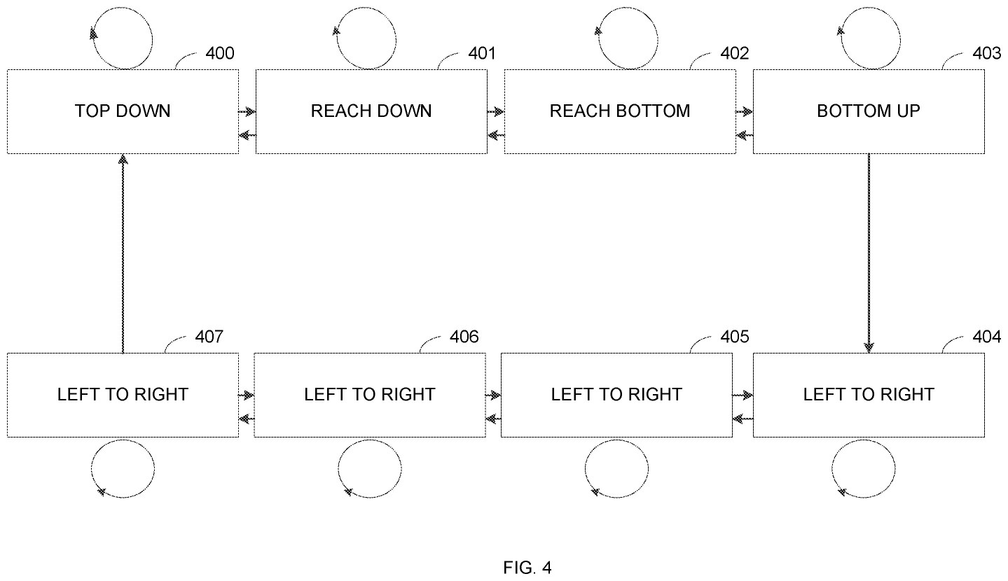

FIG. 4 is a diagram illustrating one example of a process workflow state diagram for a 3D print process. For example, the process workflow state diagram may be stored such that accessed thermal images may be associated with a state in the process workflow state diagram. States 400-403 related to a vertical movement up and down a 3D print build area may be related to a first 3D print mechanism, such as to movement of a build material spreader. States 404-407 related to a horizontal movement left to right may be related to a second 3D print mechanism, such as a print bar for distributing a fusing agent. Each state is shown to be iterative because any suitable number of thermal images may be captured at each state. For example, the 3D print mechanism may be in state 400 moving top to bottom for a longer period of time causing more thermal images to be associated with the state 400. In some cases, the 3D print process workflow may repeat the movement of the same 3D print mechanism prior to causing another 3D print mechanism to move. For example, a 3D print bar may move top down and back bottom to top prior to a second 3D print mechanism moving across the 3D print build area horizontally.

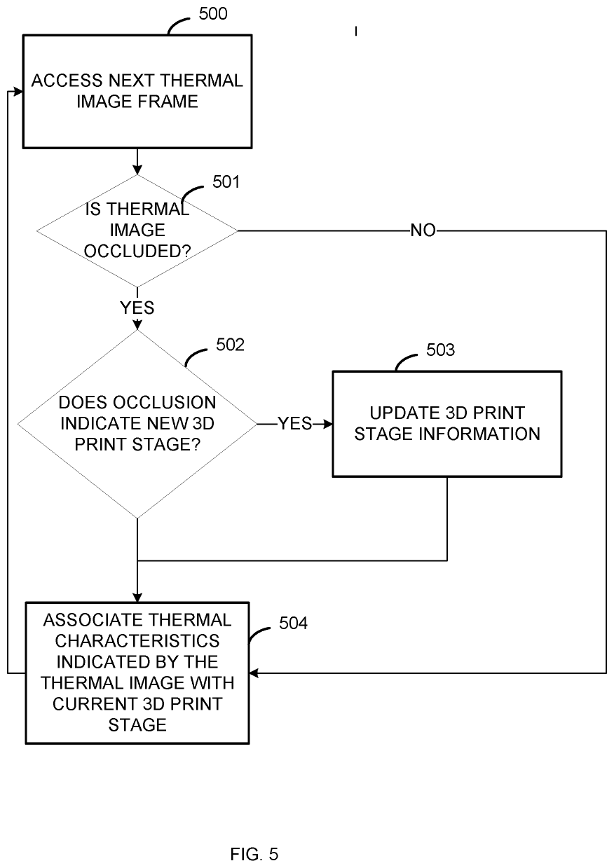

FIG. 5 is a flow chart illustrating one example of a method to synchronize a thermal image with a 3D print process. The method may be implemented, for example, by the computing system 100 of FIG. 1.

Beginning at 500, a processor accesses a next thermal image frame. The thermal image may be accessed during a 3D printing process and/or from thermal video recording. The processor may access each thermal image in a series. In one implementation, the processor accesses thermal image frames at a particular interval or accesses aggregate thermal image information from a set of thermal images captured in close time proximity.

Continuing to 501, the processor determines if the thermal image is occluded. For example, the processor may compare the thermal image to previously captured thermal images to determine if the thermal image includes occluded portions.

If yes, moving to 502, the processor determines if the occlusion indicates a new 3D print stage. For example, the processor may determine characteristics related to the occlusion, such as the orientation of occluded pixels. The processor may associate the orientation with a 3D print process stage and determine if the associated 3D print process stage is different from the current 3D print process stage. For example, the current 3D print process stage may be a stage associated with a build material spreader moving from top to bottom across the print bed. The orientation of the occluded portion may change to vertical to indicate that a new print step is taking place.

If the 3D print process stage is different from the current 3D print process stage, the method moves to 503 to update the 3D print process stage.

Continuing to 504, the processor associates the thermal characteristics indicated by the thermal image with the current 3D print process stage. For example, if the thermal image was not occluded, the method associates the thermal characteristic with the current 3D print process stage. If the thermal image was occluded, the processor associates thermal characteristics indicated by non-occluded portions with the current 3D print process stage. The thermal characteristics may be associated with a print layer mask associated with the current 3D print process stage. For example, the thermal information may be overlaid the print layer mask indicating which areas of the layer are fused and which are unfused. The method them continues to 500 to the access the next thermal image frame.

Synchronizing thermal information based on the thermal images themselves allows for thermal information to be more useful without being dependent on an expensive or complicated firmware integration between a thermal camera and 3D print process workflow.

1. A system, comprising:
a thermal camera positioned to capture thermal images of a 3D printer build area;
a processor to:
identify occlusion in a first thermal image captured by the thermal camera during a 3D print process based on a comparison of the first thermal image to a previously captured second thermal image;
associate a 3D print process stage with the first thermal image based on a 3D printer movement indicated by the identified occlusion; and
output information about the thermal characteristics of the 3D print process based on the associated first thermal image.

2. The system of claim 1, wherein determining a 3D print process stage associated with the first thermal image, comprises:
determining an orientation of a region of occluded pixels within the first thermal image; and
determining the 3D print process stage based on the determined orientation.

3. The system of claim 2, wherein associating the first thermal image with a 3D print process stage comprises:
associated the first thermal image with a build material process if the determined orientation is in a first direction; and
associating the first thermal with an agent distribution process if the determined orientation is in a second direction.

4. The system of claim 2, wherein determining an orientation of a region of occluded pixels comprises fitting a line in relation to the region of occluded pixels.

5. The system of claim 1, wherein identifying occlusion comprises identifying occlusion based on a comparison of whether a value difference in a pixel position between the first thermal image and a second thermal image is above a threshold.

6. The system of claim 1, further comprising a storage to store process workflow information of a 3D print process, wherein determining the 3D print process stage comprises comparing identified occlusion with the stages of the process workflow.

7. A method, comprising:
comparing, by a processor, a first thermal image of a 3D print build area during a 3D print process to a previously captured thermal image to detect occlusion within the first thermal image;
determining a first 3D print process step associated with the first thermal image based on a 3D printer movement indicated by the detected occlusion in the first thermal image;
detecting occlusion within a second thermal image of the 3D print build area during the 3D print process;
determining a second 3D print process step associated with the second thermal image based on a 3D printer movement indicated by the detected occlusion in the second thermal image; and
outputting information about the thermal characteristics of the 3D print process based on the first and second thermal images and associated 3D print process steps.

8. The method of claim 7, further comprising determining information related to thermal uniformity of a print layer based on the thermal characteristics.

9. The method of claim 7, wherein the first 3D print process stage is associated with at least one of build material spreading, fusing agent distribution, color agent distribution, conductive material distribution, or energy application parameters.

10. The method of claim 7, wherein comparing the first thermal image to a previously captured thermal image to detect occlusion, comprises:
identifying pixel differences above a threshold between the first thermal image and the previously captured thermal image; and
detecting occlusion if the number of identified pixels in the first thermal image is above a threshold.

11. The method of claim 7, wherein determining a first 3D print process step comprises determining the first 3D print process step based on an orientation of a region of the detected occlusion.

12. The method of claim 7, further comprising creating 3D print process workflow information based on the first and second 3D print process steps.

13. A machine-readable non-transitory storage medium comprising instructions executable by a processor to:
synchronize a thermal image in a set of thermal images with a step in a 3D printing process based on an occluded region detected in the thermal image; and
output thermal information associated with the 3D printing process step.

14. The machine-readable non-transitory storage medium of claim 13, further comprising instructions to associate a print layer mask with the thermal image based on the 3D printing process step associated with the thermal image and wherein the outputted thermal information is associated with the print layer mask.

15. The machine-readable non-transitory storage medium of claim 13, wherein instructions to synchronize the thermal image comprises instructions to synchronize the thermal image based on at least one of the orientation, position, and size of the occluded region.
